(19) United States
(12) Patent Application Publication
(10) Pub. No.: US 2014/0156934 A1
(43) Pub. Date: Jun. 5, 2014

(54) STORAGE APPARATUS AND MODULE-TO-MODULE DATA TRANSFER METHOD

(71) Applicant: FUJITSU LIMITED, Kawasaki-shi (JP)

(72) Inventor: Sadayuki Ohyama, Chigasaki (JP)

(73) Assignee: FUJITSU LIMITED, Kawasaki-shi (JP)

(21) Appl. No.: 14/031,494

(22) Filed: Sep. 19, 2013

(30) Foreign Application Priority Data
Nov. 30, 2012 (JP) 2012-261923

(51) Int. Cl. G06F 12/08

(52) U.S. Cl. CPC G06F 12/0875
USPC 711/123

(57) ABSTRACT

A storage apparatus includes controller modules configured to have a cache memory and to control a storage device, respectively, and communication channels that connect the controller modules in a mesh topology, where one controller module providing an instruction to perform data transfer in which the controller module is specified as a transfer source and another controller module is specified as a transfer destination. The instruction is provided to a controller module directly connected to the other controller modules using a corresponding one of the communication channels, and configured to perform data transfer from the cache memory of the one controller module to the cache memory of the other controller module, in accordance with the instruction.

### CROSS-REFERENCE TO RELATED APPLICATIONS

This application is based upon and claims the benefit of priority of the prior Japanese Patent Application No. 2012-261923, filed on Nov. 30, 2012, the entire contents of which are incorporated herein by reference.

### FIELD

The embodiments discussed herein are related to a storage apparatus and a module-to-module data transfer method.

### BACKGROUND

There is a storage device that includes a plurality of controller modules each of which includes a cache memory and which performs access control for access to a disk, and that configures a redundant array of inexpensive disks (RAID). When the storage apparatus accepts, from a host computer, a request to write user data into a disk, the storage apparatus holds the user data in the cache memory of one of the controller modules. Furthermore, the storage apparatus copies the user data into the cache memory of another one of the controller modules in order to protect the user data, and asynchronously writes the user data into one of the disks.

In order to perform data transfer such as copying of user data, communication channels with which the controller modules are able to communicate with each other are provided between the controller modules. In the storage apparatus, in order to have redundancy of data transfer paths, each of the communication channels is provided with two switches that connect between the corresponding controller modules. Accordingly, the storage apparatus has redundancy of data transfer paths in the case of data transfer between the controller modules, and achieves distribution of communication loads.

Japanese Laid-open Patent Publications No. 2009-266119 and No. 2005-275829 are examples of the related art.

Regarding redundancy of data transfer paths using the switches, severe damage to the redundancy configuration and marked reduction in the data transfer capability due to malfunctioning of the switches occur. Furthermore, regarding redundancy of data transfer paths using the switches, among the controller modules, a controller module that is specified as a transfer source is not able to check a state of communication between the corresponding switch and a controller module that is specified as a transfer destination. Accordingly, the controller module that is specified as a transfer source is required to inquire regarding the communication state of the controller module that is specified as a transfer destination. Thus, this is overhead in the storage device.

Even in a storage apparatus in which a plurality of controller modules are connected to each other in a mesh topology, in the case where, among the controller modules, a controller module that relays data in the case of data transfer is present between a controller module that is specified as a transfer source and a controller module that is specified as a transfer destination, there is similar overhead.

### SUMMARY

According to an aspect of the invention, a storage apparatus includes first, second, and third controller modules configured to have a cache memory and to control a storage device, respectively, and communication channels that connect the first, second, and third controller modules in a mesh topology, where the first controller module provides an instruction, for the third controller module, to perform data transfer specifying the first controller module as a transfer source and the second controller module as a transfer destination. The third controller module, according to an aspect, being directly connected with each of the first and second controller modules using a corresponding one of the communication channels, and the third controller module configured to perform data transfer from the cache memory of the first controller module to the cache memory of the second controller module in accordance with the instruction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an example of a configuration of a storage apparatus according to a first embodiment;

FIG. 2 is a diagram illustrating an example of a configuration of a storage apparatus according to a second embodiment;

FIG. 3 is a diagram illustrating examples of transmission channels between controller modules in the second embodiment;

FIG. 4 is a diagram illustrating an example of a configuration of a controller module in the second embodiment;

FIG. 5 is a diagram illustrating an example of a configuration of a data transfer controller in the second embodiment;

FIG. 6 is a diagram illustrating performance information held by a performance-information transmission buffer in the second embodiment;

FIG. 7 is a diagram illustrating performance information held by a performance-information storage buffer in the second embodiment;

FIG. 8 is a flowchart of a write-request accepting process in the second embodiment;

FIG. 9 is a flowchart of a read-request accepting process in the second embodiment;

FIG. 10 is a flowchart of a user-data transfer process in the second embodiment;

FIG. 11 is a diagram illustrating a descriptor in the second embodiment;

FIG. 12 is a flowchart of a data-flow-rate-table generating process in the second embodiment;

FIG. 13 is a diagram illustrating a data-flow-rate table in the second embodiment;

FIG. 14 is a flowchart of a transfer-destination determination process in the second embodiment;

FIG. 15 is a flowchart of a transfer instruction process in the second embodiment; and

FIG. 16 is a flowchart of a transfer-instruction accepting process in the second embodiment.

### DETAILED DESCRIPTION

Hereinafter, embodiments will be described in detail with reference to the drawings, where like reference numerals refer to the like elements throughout. The embodiments are described below to explain the present invention by referring to the figures. While the invention is described with specific embodiments (first embodiment, second embodiment, etc.), the embodiments are not limited to any specific operation and/or hardware configuration. For example, any component and/or operation of one embodiment may be implemented with the other embodiments.

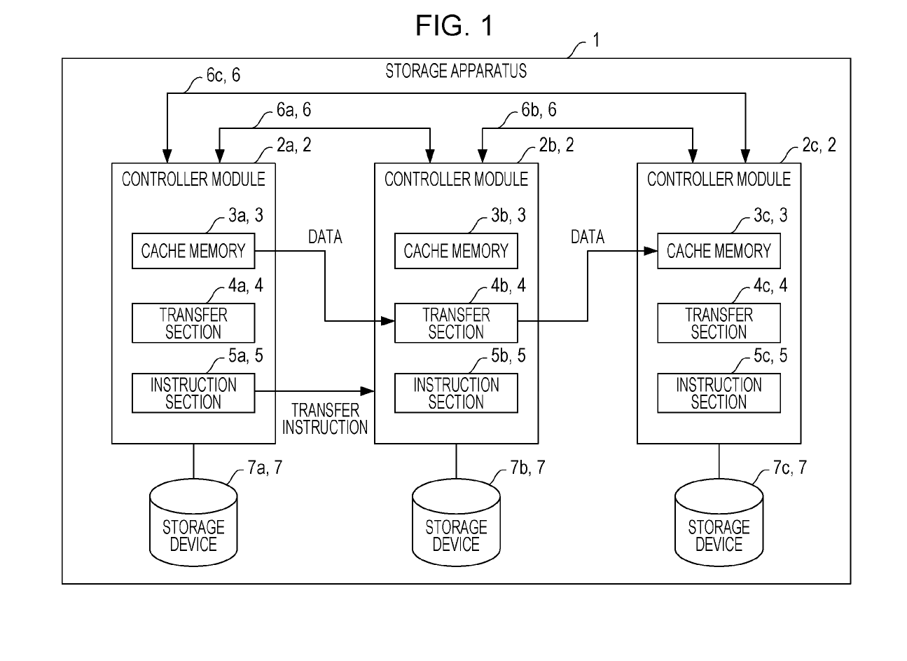

First, a storage apparatus according to a first embodiment will be described using FIG. 1. FIG. 1 is a diagram illustrating an example of a configuration of the storage apparatus according to the first embodiment.

A storage apparatus 1 is a control apparatus that performs access control for access to storage devices (information recording devices) 7. The storage apparatus 1 is connected with a host computer, which is not illustrated, so as to be capable of communicating with the host computer, and accepts an instruction (a write command, a read command, or the like) from the host computer.

The storage apparatus 1 includes the plurality of storage devices 7, and enable configuration of a RAID.

Each of the storage devices 7 is capable of recording desired information such as user data or control information, and is, for example, a hard disk drive (HDD) or a solid state drive (SSD: flash memory drive). Note that the storage device 7 may be a disk array that includes a plurality of HDDs or SSDs.

The storage apparatus 1 includes a plurality of controller modules 2 (a first controller module 2a, a second controller module 2b, a third controller module 2c). Because the first controller module 2a, the second controller module 2b, and the third controller module 2c are connected with each other using communication channels 6 in a mesh topology so as to be capable of communicating with each other. Using the communication channels 6 (6a, 6b, 6c) that are illustrated in FIG. 1 and that are arranged in a mesh topology, all of the controller modules 2 are fully connected with each other. The controller module 2a and the controller module 2b are directly connected with each other using the communication channel 6a, and are indirectly connected with each other using the communication channels 6b and 6c via the controller module 2c that relays data so that the data is transferred with a hop count of 1. The controller module 2b and the controller module 2c are directly connected with each other using the communication channel 6b, and are indirectly connected to each other using the communication channels 6c and 6a via the controller module 2a that relays data so that the data is transferred with a hop count of 1. The controller module 2c and the controller module 2a are directly connected to each other using the communication channel 6c, and are indirectly connected to each other using the communication channels 6a and 6b via the controller module 2b that relays data so that the data is transferred with a hop count of 1.

Each of the controller modules 2 (2a, 2b, 2c) includes a corresponding one of cache memories 3 (3a, 3b, 3c), a corresponding one of transfer sections 4 (4a, 4b, 4c), and a corresponding one of instruction sections 5 (5a, 5b, 5c), and performs access control for access to a corresponding one of the storage devices 7 that is connected to the controller module 2. The cache memory 3 stores user data, serves as a cache in the case where data has been read from the storage device 7, and serves as a buffer in the case where data is to be written into the storage device 7. Furthermore, the cache memory 3 also serves as a working memory in which desired control information is stored.

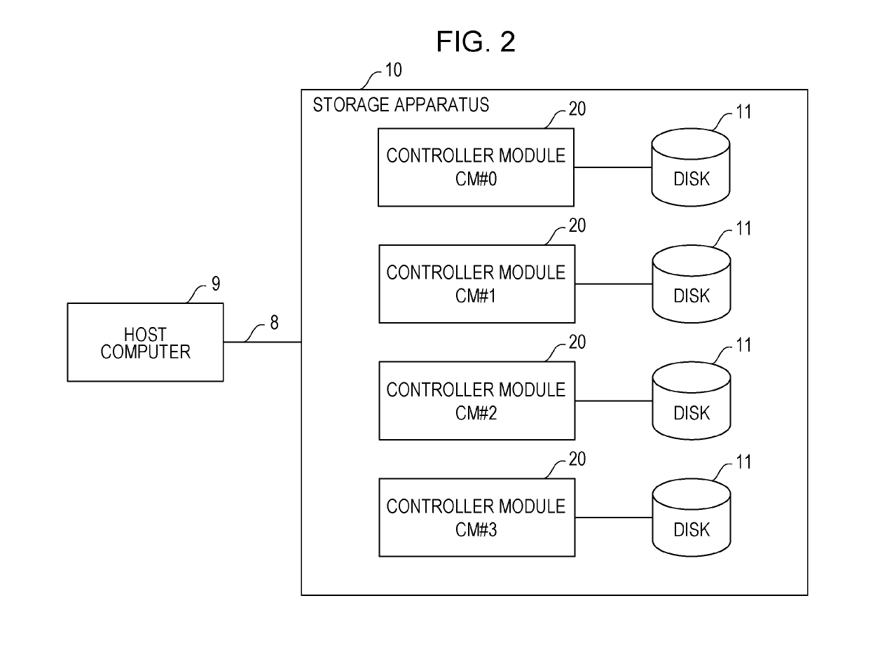

The transfer section 4 performs data transfer using the cache memory 3 as a transfer source or a transfer destination. Regarding the instruction section 5, when a communication path along which a controller module 2 including an instruction section 5 is specified as a transfer source and along which a controller module 2 that is to relay data in the case of data transfer to a controller module 20 (FIG. 2) is specified as a transfer destination is selected, the instruction section 5 provides, for the controller module 2 that is to relay data, an instruction to perform data transfer.

In the case of data transfer in which the controller module 2a (the first controller module) is specified as a transfer source and in which the controller module 2c (the third controller module) is specified as a transfer destination, the communication channel 6c, which directly connects the controller modules 2a and 2c, and the communication channels 6a and 6b, which indirectly connect the controller modules 2a and 2c, may be used as communication paths.

In the case where the communication channel 6c, which directly connects the controller modules 2a and 2c, is used as a communication path, the controller module 2a performs, using the transfer section 4a, data transfer in which the controller module 2a is specified as a transfer source and in which the controller module 2c is specified as a transfer destination. The transfer section 4a performs data transfer from the cache memory 3a to the cache memory 3c.

In contrast, in the case where the communication channels 6a and 6b, which indirectly connect the controller modules 2a and 2c, is used as a communication path, the controller module 2a provides, using the instruction section 5a, for the controller module 2b (the second controller module) that is to relay data in the case of data transfer, an instruction to perform data transfer. The controller module 2b has accepted the instruction from the instruction section 5a, and performs, using the transfer section 4b, data transfer in which the controller module 2a is specified as a transfer source and in which the controller module 2c is specified as a transfer destination. The transfer section 4b performs data transfer from the cache memory 3a to the cache memory 3c.

In this manner, the storage apparatus 1 may have redundancy of data transfer paths without requiring use of switches. Thus, severe damage to the redundancy configuration and marked reduction in the data transfer capability due to malfunctioning of switches do not occur. Furthermore, in the storage apparatus 1, in the case of direct data transfer between controller modules 2 among the controller modules 2, the transfer section 4 of a transfer source may check a communication state. In the case of data transfer via a controller module 2, among the controller modules 2, that relays data, the transfer section 4 that relays data may check a communication state. Therefore, the storage apparatus 1 may guarantee, without any heavy load, data transfer in module-to-module communication using the redundancy of data transfer paths.

Next, an example of a configuration of a storage apparatus according to a second embodiment will be described using FIG. 2. FIG. 2 is a diagram illustrating an example of the configuration of the storage apparatus according to the second embodiment.

A storage apparatus 10 is connected to a host computer 9 via a network 8 so as to be capable of communicating with the host computer 9. The network 8, for example, is a storage area network (SAN) in which one or a plurality of storage apparatuses 10 and one or a plurality of host computers 9 are connected to each other.

The storage apparatus 10 includes a plurality of controller modules 20 (CM#0, CM#1, CM#2, CM#3). Each of the controller modules 20 is connected with a corresponding one of disks (storage devices) 11, and performs access control for access to the disk 11.

Note that, although the storage apparatus 10 illustrated in FIG. 2 includes four controller modules 20, the storage apparatus 10 may include at least three controller modules 20 which are a controller module 20 that is specified as a transfer source, a controller module 20 that is specified as a transfer destination, and a controller module 20 that relays data in the case of data transfer. For example, the storage apparatus 10 may include six or eight controller modules 20.

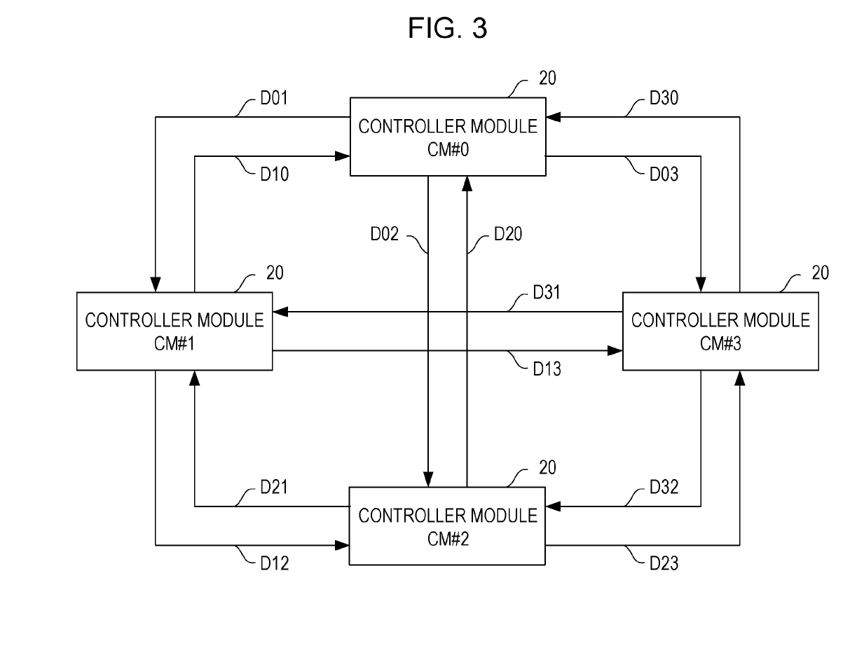

Next, transmission channels between the controller modules in the second embodiment will be described using FIG. 3. FIG. 3 is a diagram illustrating examples of the transmission channels between the controller modules in the second embodiment.

The individual controller modules 20 are fully connected to each other so as to be capable of communicating with each other. A transmission channel in the direction from a controller module CM#x to a controller module CM#y among the individual controller modules 2 is denoted by Dxy. For example, a transmission channel in the direction from a controller module CM#0 to a controller module CM#2 is denoted by D02. A transmission channel in a direction opposite to the direction is denoted by D20.

Regarding each of the controller modules 20, when the controller module 20 is specified as a transfer source in the case of data transfer, the controller module 20 has the following communication paths: a communication path along which the controller module 20 is directly connected to a controller module 20, among the controller modules 20, that is specified as a transfer destination; and a communication path along which data is relayed to the transfer destination so that the data is transferred with a hop count of “1”. For each of the communication paths, transmission channels in two directions that are opposite to each other are provided.

For example, transmission channels that directly connect the controller module CM#0 and the controller module CM#2 are transmission channels D02 and D20. Furthermore, the controller module CM#0 has two communication paths along which the controller module CM#0 is connected to the controller module CM#2 so that data is transferred with a hop count of “1”. Transmission channels that indirectly connect the controller module CM#0 and the controller module CM#2 via the controller module CM#1 which relays data are transmission channels D01 and D10 between the controller modules CM#0 and CM#1 and transmission channels D21 and D12 between the controller modules CM#1 and CM#2. Transmission channels that indirectly connect the controller module CM#0 and the controller module CM#2 via the controller module CM#3 which relays data are transmission channels D03 and D30 between the controller modules CM#0 and CM#3 and transmission channels D23 and D32 between the controller modules CM#3 and CM#2.

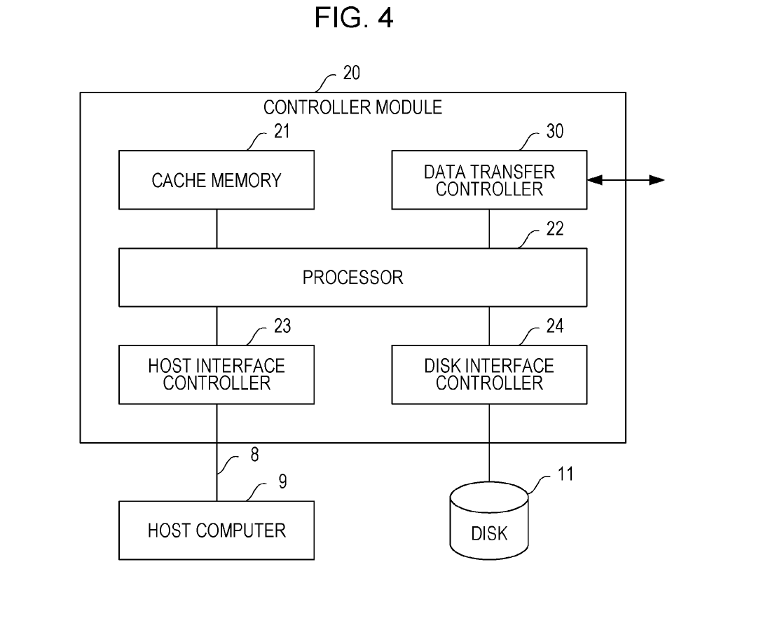

Next, a configuration of each of the controller modules in the second embodiment will be described using FIG. 4. FIG. 4 is a diagram illustrating an example of the configuration of each of the controller modules in the second embodiment.

Each of the controller modules 20 includes a cache memory 21, a processor 22, a host interface controller 23, a disk interface controller 24, and a data transfer controller 30.

The processor 22 corresponds to a control section that performs overall control of the controller module 20 and a RAID process. The processor 22 is connected with the cache memory 21, the host interface controller 23, the disk interface controller 24, and the data transfer controller 30 via buses that are not illustrated.

The processor 22 may be, for example, a central processing unit (CPU), a micro processing unit (MPU), a digital signal processor (DSP), an application specific integrated circuit (ASIC), or a programmable logic device (PLD). Furthermore, the processor 22 is not limited to a single processor, and may be a multiprocessor. Moreover, the processor 22 may be a combination of at least two elements among a CPU, a MPU, a DSP, an ASIC, and a PLD.

The host interface controller 23 is connected to the host computer 9 via the network 8. The host interface controller 23 accepts an access request (a read request, a write request, or the like) from the host computer 9, and notifies the processor 22 of the access request. Furthermore, the host interface controller 23 stores, in the cache memory 21, user data that has been received from the host computer 9, and transmits, to the host computer 9, user data stored in the cache memory 21.

The disk interface controller 24 is connected to a disk 11. The disk interface controller 24 accesses the disk 11 in accordance with an access request (a read request, a write request, or the like) provided from the processor 22. The disk interface controller 24 stores, in the cache memory 21, user data that has been read from the disk 11, and writes, into the disk 11, user data stored in the cache memory 21.

The cache memory 21 is configured using a random access memory (RAM) or a nonvolatile memory. Because the cache memory 21 temporarily stores user data, a rapid response to an access request from the host computer 9 to the storage apparatus 10 is made possible. Furthermore, the cache memory 21 is used as a main storage device of the controller module 20. In the cache memory 21, at least one portion of an operating system (OS), a firmware, and an application that are performed by the processor 22 are temporarily stored. Moreover, in the cache memory 21, various types of data for processes performed by the processor 22 are stored.

A nonvolatile memory holds stored contents when the power of the storage apparatus 10 is shut off. The nonvolatile memory may be, for example, a semiconductor storage device, such as an electrically erasable programmable read-only memory (EEPROM) or a flash memory, or an HDD. Furthermore, the nonvolatile memory is used as an auxiliary storage device of the controller module 20. In the nonvolatile memory, the OS, a firmware, an application, and various types of data are stored.

The data transfer controller 30 has a function of transferring a copy of user data stored in the cache memory 21 to another one of the controller modules 20. The data transfer controller 30 performs data transfer of user data in accordance with an instruction provided by the processor 22.

With the above-described hardware configuration, processing functions of the controller module 20 in the second embodiment may be realized. Furthermore, each of the controller modules 2 in the first embodiment may also be realized using hardware similar to the hardware of the controller module 20.

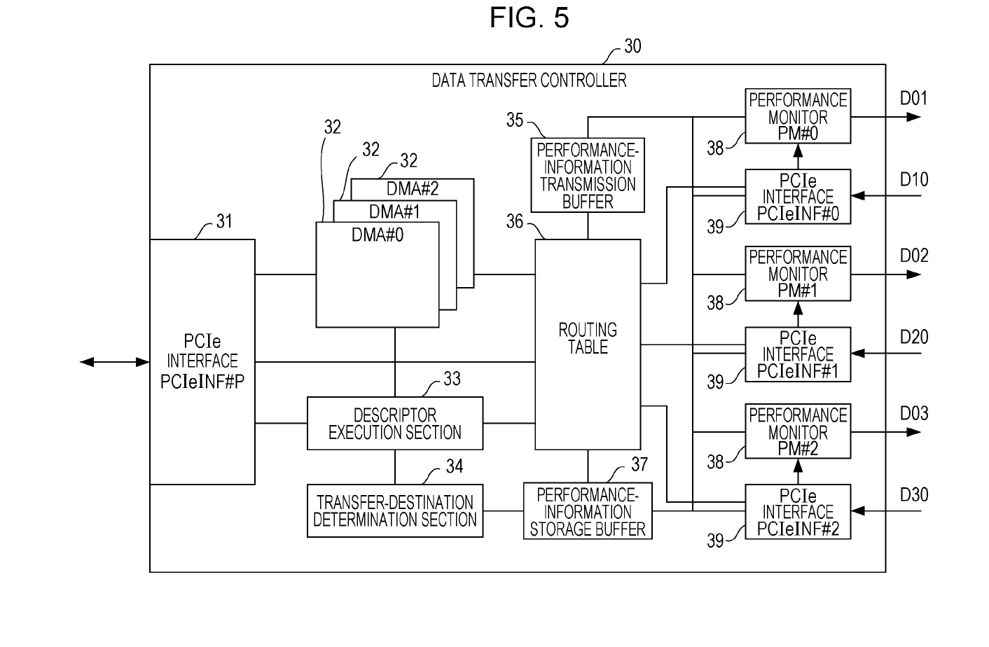

Next, a configuration of the data transfer controller in the second embodiment will be described using FIG. 5. FIG. 5 is a diagram illustrating an example of the configuration of the data transfer controller in the second embodiment.

The data transfer controller 30 includes Peripheral Component Interconnect Express (PCIe) interfaces 31 and 39, performance monitors 38, direct memory accesses (DMAs) 32, a descriptor execution section 33, and a transfer-destination determination section 34. Moreover, the data transfer controller 30 further includes a performance-information transmission buffer 35, a routing table 36, and a performance-information storage buffer 37.

Note that the PCIe interfaces 31 and 39, the performance monitors 38, the DMAs 32, the descriptor execution section 33, and the transfer-destination determination section 34 may be realized using an electronic circuit such as a DSP, an ASIC, or a PLD. Furthermore, the data transfer controller 30, the performance-information transmission buffer 35, the routing table 36, and the performance-information storage buffer 37 may be realized using an electronic circuit such as a DSP, an ASIC, or a PLD.

The PCIe interface 31 (PCIeINF#p) is connected with the DMAs 32, the descriptor execution section 33, and the routing table 36. The PCIe interface 31 is a data transfer interface that connects the processor 22 and the data transfer controller 30 so that the processor 22 and the data transfer controller 30 are able to communicate with each other using PCIe.

The PCIe interfaces 39 (PCIeINF#0, PCIeINF#1, PCIeINF#2) are connected with the performance-information transmission buffer 35, the routing table 36, and the performance-information storage buffer 37. Each of the PCIe interfaces 39 is a data transfer interface that connects two corresponding controller modules 20 among the controller modules 20 so that the two controller modules 20 are able to communicate with each other using PCIe.

Each of the performance monitors 38 (PM#0, PM#1, PM#2) is connected to a corresponding one of the PCIe interfaces 39, the performance-information transmission buffer 35, and the performance-information storage buffer 37. The performance monitor 38 monitors the rate of a flow of data (a data flow rate) that is transferred to another one of the controller modules 20 via the corresponding PCIe interface 39. For example, the performance monitor PM#0 monitors the rate of a flow of data that is transferred by the PCIe interface PCIeINF#0 to another one of the controller modules 20. The performance monitor 38 notifies the performance-information transmission buffer 35 and the performance-information storage buffer 37 of the monitored data flow rate.

The performance-information transmission buffer 35 is connected to the PCIe interfaces 39, the performance monitors 38, the routing table 36, and the performance-information storage buffer 37. The performance-information transmission buffer 35 transmits, via the PCIe interface 31, to another one of the controller modules 20, performance information including the data flow rates monitored by the performance monitors 38.

The performance-information storage buffer 37 is connected with the PCIe interfaces 39, the performance monitors 38, the routing table 36, the performance-information transmission buffer 35, and the transfer-destination determination section 34. The performance-information storage buffer 37 stores the performance information based on monitoring performed by the performance monitors 38, and performance information received from the other controller modules 20.

The routing table 36 is connected with the PCIe interfaces 31 and 39, the DMAs 32, the descriptor execution section 33, the performance-information transmission buffer 35, and the performance-information storage buffer 37. The routing table 36 connects the PCIe interfaces 31 and 39, the DMAs 32, the descriptor execution section 33, the performance-information transmission buffer 35, and the performance-information storage buffer 37 to each other.

The transfer-destination determination section 34 is connected with the descriptor execution section 33 and the performance-information storage buffer 37. The transfer-destination determination section 34 determines, based on the performance information stored in the performance-information storage buffer 37, a communication path to a transfer destination in the case of data transfer.

The descriptor execution section 33 is connected to the PCIe interface 31, the DMAs 32, the transfer-destination determination section 34, and the routing table 36. The descriptor execution section 33 reads a descriptor that has been generated and stored in the cache memory 21 by the processor 22, and issues a DMA activation instruction.

The descriptor is control information (transfer control information) concerning data transfer. The descriptor includes, as control information, the address of a transfer source, the address of a transfer destination, the amount of data to be transferred, and the address of a transfer-result notification destination which is to be notified of a transfer result. The descriptor execution section 33 issues a DMA activation instruction to a controller module 20, among the controller modules 20, that is related to the communication path determined by the transfer-destination determination section 34.

Each of the DMAs 32 is connected with the PCIe interface 31, the descriptor execution section 33, and the routing table 36. The DMA 32 performs data transfer without the processor 22 in accordance with a DMA activation instruction. A plurality of DMAs 32 are provided as the DMAs 32, and are denoted by DMA#0, DMA#1, and DMA#2. Each of the DMAs 32 is in control of data transfer.

The DMA 32 performs data transfer for a specified address range with reference to the descriptor. Each of the DMAs 32 of a controller module 20, among the controller modules 20, that is specified as a transfer source is capable of performing data transfer from the cache memory 21 to a controller module 20, among the controller modules 20, that is specified as a transfer destination. Furthermore, each of the DMAs 32 of a controller module 20, among the controller modules 20, that relays data in the case of data transfer is capable of performing data transfer from a controller module 20 that is specified as a transfer source to a controller module 20 that is specified as a transfer destination among the controller modules 20.

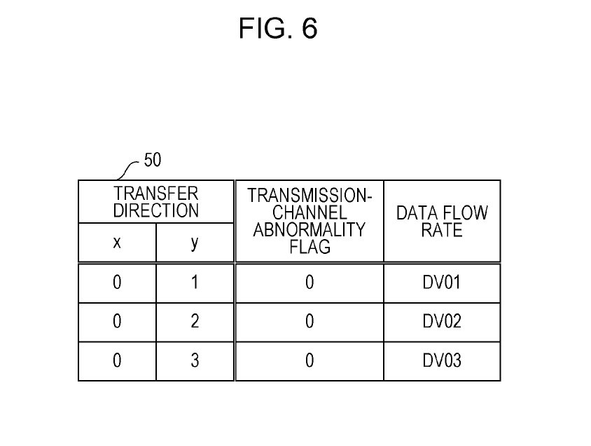

Next performance information held by the performance-information transmission buffer in the second embodiment will be described using FIG. 6. FIG. 6 is a diagram illustrating performance information held by the performance-information transmission buffer in the second embodiment.

Performance information 50 is an example of performance information held by the performance-information transmission buffer 35 of the controller module CM#0. The performance information 50 is information including, in the case where the controller module CM#0 is specified as a transfer source, for each of the transmission channels, whether a transmission-channel abnormality flag of the transmission channel is set or cleared and the data flow rate of the transmission channel. A data flow rate DVxy is a data flow rate of the transmission channel in the transfer direction from the controller module CM#x to the controller module CM#y. For example, a data flow rate DV01 is a data flow rate of the transmission channel in the transfer direction from the controller module CM#0 to the controller module CM#1. Regarding the transmission-channel abnormality flag, for example, “0” indicates normality, and “other than 0 (for example, 1)” indicates abnormality.

The data flow rate and the transmission-channel abnormality flag of each of the transmission channels are collected at a predetermined timing (for example, every one second) from a corresponding one of the performance monitors 38, and are transmitted to the other controller modules 20 at a predetermined timing (for example, every one second).

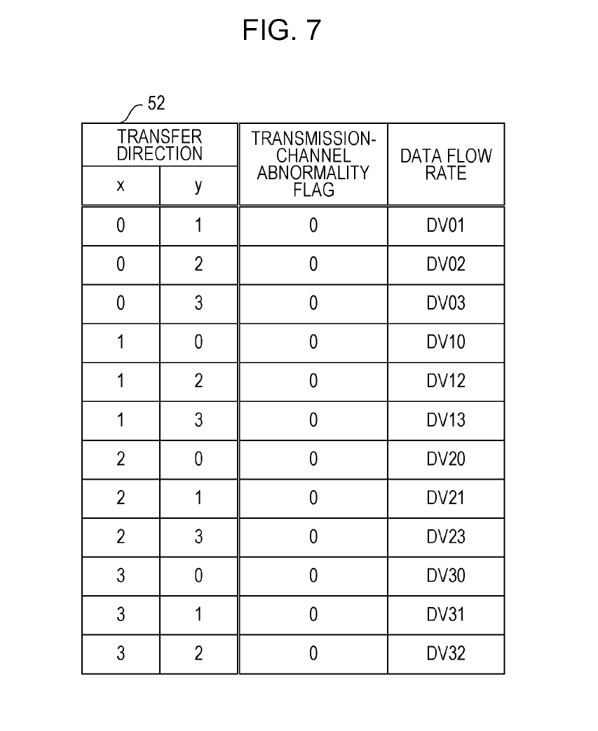

Next, performance information held by the performance-information storage buffer in the second embodiment will be described using FIG. 7. FIG. 7 is a diagram illustrating performance information held by the performance-information storage buffer in the second embodiment.

Performance information 52 is an example of performance information held by the performance-information storage buffer 37 of the controller module CM#0. The performance information 52 is information including performance information collected from the performance monitors 38 by the controller module CM#0 and performance information received from the other controller modules 20 (CM#01, CM#02, CM#03).

In this manner, the individual controller modules 20 may grasp the data flow rate of each of the transmission channels and whether or not abnormality occurs in the transmission channel.

Next, a write-request accepting process and a read-request accepting process in the second embodiment will be described. The write-request accepting process and the read-request accepting process are processes that are performed by the processor 22 when a write request and a read request, respectively, have been accepted from the host computer 9. The write request is a request to write user data into the disk 11, and the read request is a request to read user data from the disk 11.

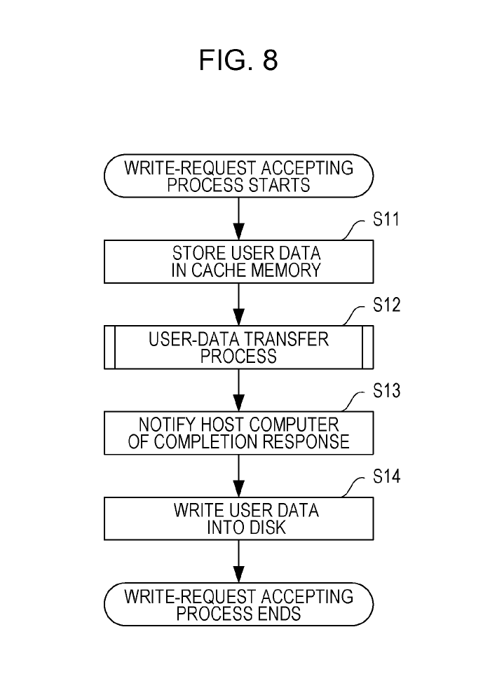

First, the write-request accepting process will be described using FIG. 8. FIG. 8 is a flowchart of the write-request accepting process in the second embodiment.

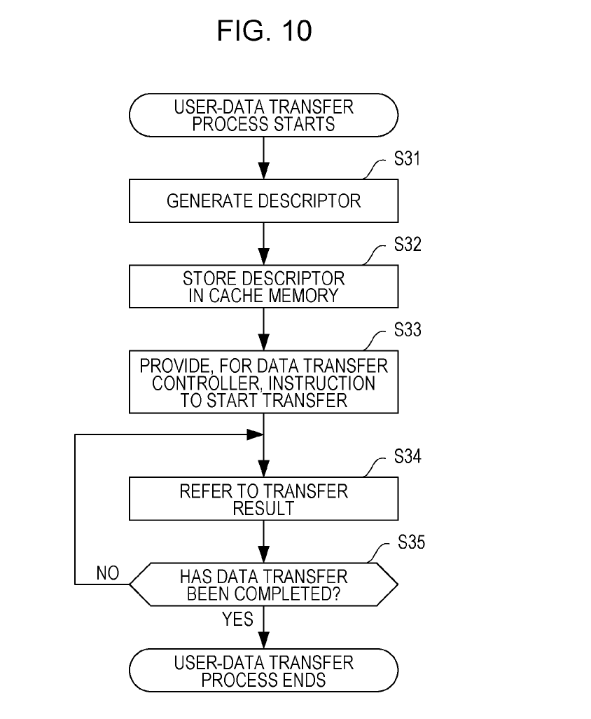

A write request from the host computer 9 to the storage apparatus 10 is accepted by the host interface controller 23 of a corresponding controller module 20 among the controller module 20. The host interface controller 23 that has accepted the write request notifies the processor 22 that the write request has been accepted, and, consequently, the processor 22 performs the write-request accepting process.

[Operation S11] The processor 22 provides, for the host interface controller 23, an instruction to store user data, for which the write request has been made, in the cache memory 21. When the host interface controller 23 has accepted this instruction, the host interface controller 23 stores the user data in the cache memory 21.

[Operation S12] The processor 22 performs a user-data transfer process. The user-data transfer process is a process of copying user data into a desired controller module 20 among the controller modules 20 in order to protect the user data stored in the cache memory 21. The details of the user-data transfer process will be described below using FIG. 10.

[Operation S13] When the user data is stored in the cache memory 21, the processor 22 notifies, via the host interface controller 23, the host computer 9 of a completion response.

[Operation S14] The processor 22 provides, for the disk interface controller 24, an instruction to write the user data into the disk 11, and finishes the write-request accepting process. When the disk interface controller 24 has accepted this instruction, asynchronously with the completion response, the disk interface controller 24 reads the user data from the cache memory 21 and writes the user data into the disk 11.

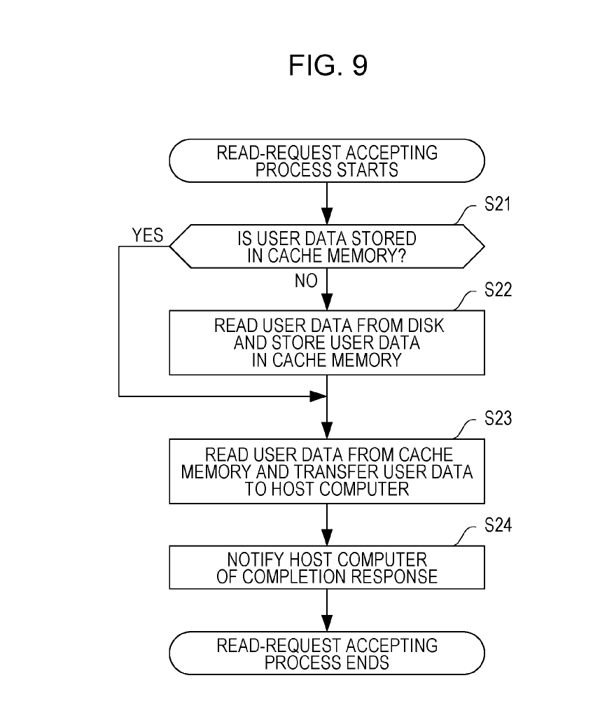

Next, the read-request accepting process will be described using FIG. 9. FIG. 9 is a flowchart of the read-request accepting process in the second embodiment.

A read request from the host computer 9 to the storage apparatus 10 is accepted by the host interface controller 23 of a corresponding controller module 20 among the controller modules 20. The host interface controller 23 that has accepted the read request notifies the processor 22 that the read request has been accepted, and, consequently, the processor 22 performs the read-request accepting process.

[Operation S21] The processor 22 determines whether or not user data for which the read request has been made is stored in the cache memory 21. When the user data for which the read request has been made is stored in the cache memory 21, the processor 22 proceeds to operation S23. When the user data is not stored in the cache memory 21, the processor 22 proceeds to operation S22.

[Operation S22] The processor 22 provides, for the disk interface controller 24, an instruction to read the user data for which the read request has been made and to store the user data in the cache memory 21. When the disk interface controller 24 has accepted this instruction, the disk interface controller 24 reads the user data from the disk 11, and stores the user data in the cache memory 21.

[Operation S23] The processor 22 provides, for the host interface controller 23, an instruction to read the user data for which the read request has been made from the cache memory 21 and to transfer the user data to the host computer 9. When the host interface controller 23 has accepted this instruction, the host interface controller 23 reads the user data from the cache memory 21, and transfers the user data to the host computer 9.

[Operation S24] The processor 22 notifies, via the host interface controller 23, the host computer 9 of a completion response, and finishes the read-request accepting process.

Next, the user-data transfer process will be described using FIG. 10. FIG. 10 is a flowchart of the user-data transfer process in the second embodiment.

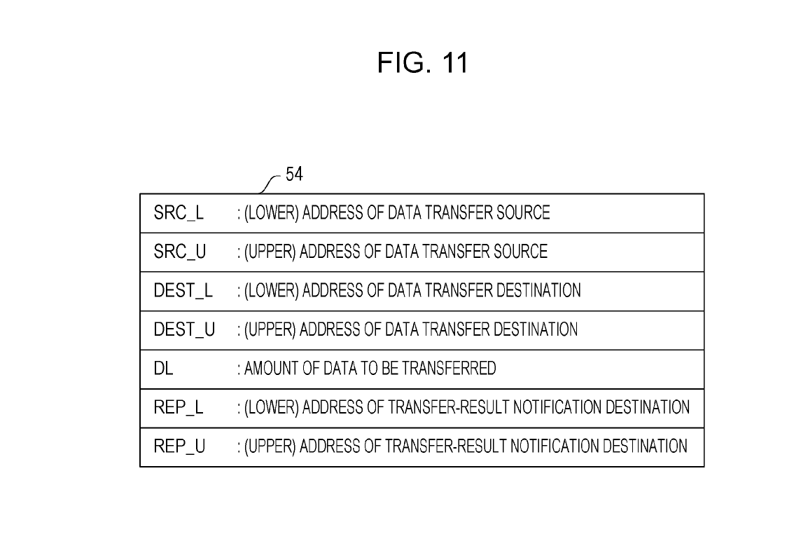

The user-data transfer process is a process that is performed by the processor 22 in operation S13 of the write-request accepting process.

[Operation S31] The processor 22 generates a descriptor. Here, the descriptor will be described using FIG. 11. FIG. 11 is a diagram illustrating the descriptor in the second embodiment.

A descriptor 54 is information that includes, in list form, the address of a data transfer source, the address of a data transfer destination, the amount of data to be transferred, and the address of a transfer-result notification destination. Regarding the address of a data transfer source, an address located in the cache memory 21 of a controller module 20, among the controller modules 20, that is specified as a data transfer source is represented by SRC_L, which represents the lower four bytes of the address, and SRC_U, which represents the upper four bytes of the address. Regarding the address of a data transfer destination, an address located in the cache memory 21 of a controller module 20, among the controller modules 20, that is specified as a data transfer destination is represented by DEST_L, which represents the lower four bytes of the address, and DEST_U, which represents the upper four bytes of the address. Regarding the amount of data to be transferred, the size of data to be transferred is represented by the number of bytes. Regarding the address of a transfer-result notification destination, an address located in the cache memory 21 of a controller module 20, among the controller modules 20, that is specified as a transfer-result notification destination is represented by REP_L, which represents the lower four bytes of the address, and REP_U, which represents the upper four bytes of the address. The controller module 20 specified as a transfer-result notification destination is the controller module 20 that is specified as a data transfer source.

[Operation S32 as shown in FIG. 10] The processor 22 stores the generated descriptor in the cache memory 21.

[Operation S33] The processor 22 specifies the descriptor stored in the cache memory 21, and provides, for the data transfer controller 30, an instruction to start transfer.

[Operation S34] The processor 22 refers to a transfer result stored at the address located in the cache memory 21 that is a transfer-result notification destination. The processor 22 refers to the transfer result, whereby the processor 22 may grasp whether or not data transfer has been completed.

[Operation S35] When data transfer has not been completed, the processor 22 proceeds to operation S34, and waits for the completion of data transfer. When data transfer has been completed, the processor 22 finishes the user-data transfer process.

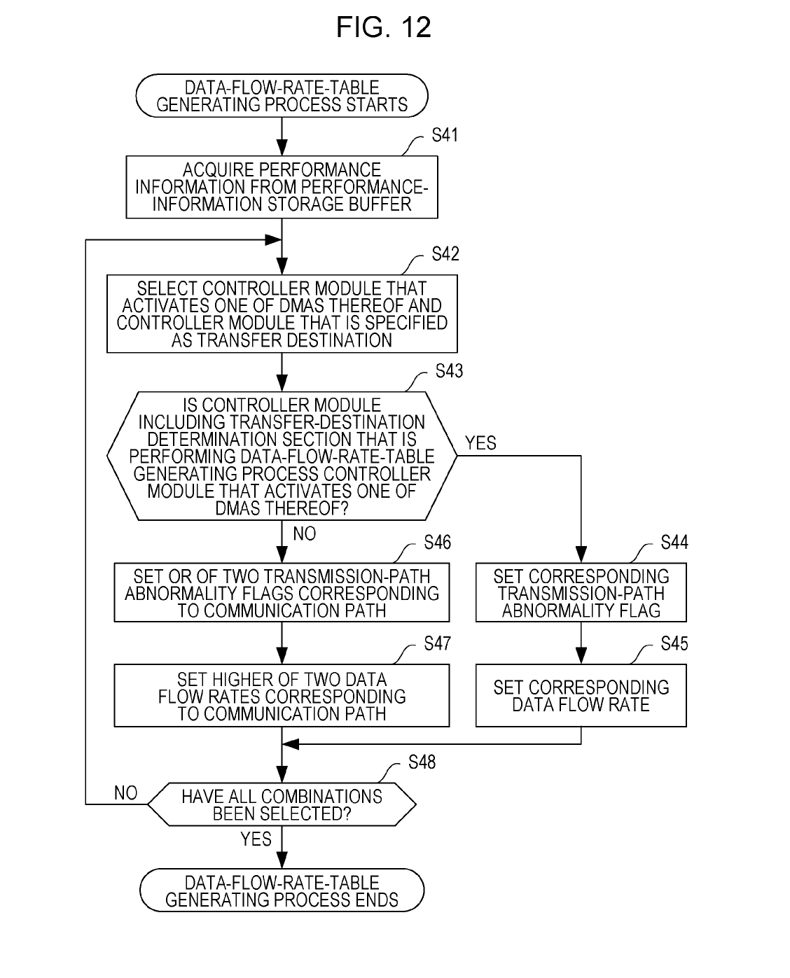

Here, a data-flow-rate-table generating process will be described using FIG. 12. FIG. 12 is a flowchart of the data-flow-rate-table generating process in the second embodiment. The data-flow-rate-table generating process is a process of generating, as a data-flow-rate table, from performance information stored in the performance-information storage buffer 37, performance information concerning communication paths along which data is relayed so that the data is transferred from a transfer source to a transfer destination with a hop count of “1”. The data-flow-rate-table generating process is a process that is performed at a predetermined timing (for example, every one second) by the transfer-destination determination section 34.

[Operation S41 as shown FIG. 12] The transfer-destination determination section 34 acquires performance information from the performance-information storage buffer 37.

[Operation S42] The transfer-destination determination section 34 selects one combination of, among the controller modules 20, a controller module 20 that activates one of the DMAs 32 thereof and a controller module 20 that is specified as a transfer destination. In the case of a communication path along which, among the controller modules 20, controller modules 20 that are specified as a transfer destination and a transfer source are directly connected to each other, the controller module 20 that activates one of the DMAs 32 thereof is the controller module 20 that is specified as a transfer source. In the case of a communication path along which, among the controller modules 20, a controller module 20 that relays data between a transfer source and a transfer destination is present between the transfer source and the transfer destination, the controller module 20 that activates one of the DMAs 32 thereof is the controller module 20 that relays data between the transfer source and the transfer destination. For example, in the case of the communication path along which the controller module CM#0 is specified as a transfer source, along which the controller module CM#1 is specified as a transfer destination, and along which the controller modules CM#0 and CM#1 are directly connected to each other, the controller module CM#0 is the controller module 20 that activates one of the DMAs 32 thereof. Furthermore, in the case of a communication path along which the controller module CM#0 is specified as a transfer source, along which the controller module CM#1 is specified as a transfer destination, and along which the controller module CM#2 relays data, the controller module CM#2 is the controller module 20 that activates one of the DMAs 32 thereof.

[Operation S43] The transfer-destination determination section 34 determines whether or not the controller module 20 including the transfer-destination determination section 34 that is performing this data-flow-rate-table generating process is the controller module 20 that activates one of the DMAs 32 thereof. When the controller module 20 including the transfer-destination determination section 34 that is performing this data-flow-rate-table generating process is the controller module 20 that activates one of the DMAs 32 thereof, the transfer-destination determination section 34 proceeds to operation S44. When the controller module 20 including the transfer-destination determination section 34 that is performing this data-flow-rate-table generating process is not the controller module 20 that activates one of the DMAs 32 thereof, the transfer-destination determination section 34 proceeds to operation S46.

[Operation S44] The transfer-destination determination section 34 sets, in a data-flow-rate table, a transmission-channel abnormality flag that has been obtained from the performance information acquired from the performance-information storage buffer 37 and that corresponds to a communication path related to the selected combination.

[Operation S45] The transfer-destination determination section 34 sets, in the data-flow-rate table, a data flow rate that has been obtained from the performance information acquired from the performance-information storage buffer 37 and that corresponds to the communication path related to the selected combination.

[Operation S46] The transfer-destination determination section 34 sets, in the data-flow-rate table, based on two transmission-channel abnormality flags that have been obtained from the performance information acquired from the performance-information storage buffer 37 and that correspond to a communication path related to the selected combination, a transmission-channel abnormality flag for the communication path. Here, the transfer-destination determination section 34 sets, in the data-flow-rate table, the OR of two transmission-channel abnormality flags corresponding to the communication path related to the selected combination.

[Operation S47] The transfer-destination determination section 34 sets, in the data-flow-rate table, based on two data flow rates that have been obtained from the performance information acquired from the performance-information storage buffer 37 and that correspond to the communication path related to the selected combination, a data flow rate for the communication path. Here, the transfer-destination determination section 34 sets, in the data-flow-rate table, the higher of two data flow rates corresponding to the communication path related to the selected combination.

[Operation S48] The transfer-destination determination section 34 determines whether or not all combinations of a controller module 20 that activates one of the DMAs 32 thereof and a controller module 20 that is specified as a transfer destination have been selected. When not all combinations of a controller module 20 that activates one of the DMAs 32 thereof and a controller module 20 that is specified as a transfer destination have been selected, the transfer-destination determination section 34 proceeds to operation S42. When all combinations of a controller module 20 that activates one of the DMAs 32 thereof and a controller module 20 that is specified as a transfer destination have been selected, the transfer-destination determination section 34 finishes the data-flow-rate-table generating process.

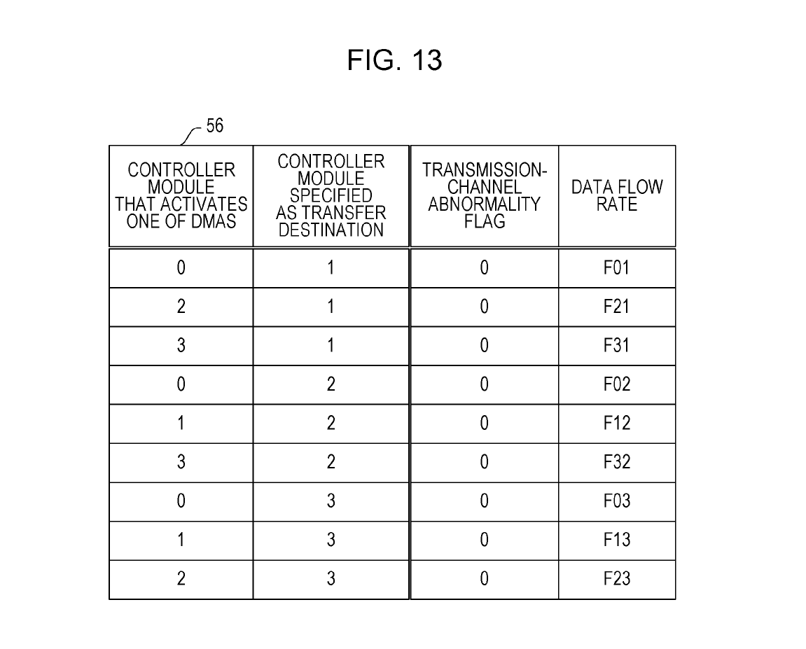

Here, the data-flow-rate table will be described using FIG. 13. FIG. 13 is a diagram illustrating the data-flow-rate table in the second embodiment. A data-flow-rate table 56 is an example of the data-flow-rate table that is generated and held by the transfer-destination determination section 34 of the controller module CM#0. Regarding communication paths along which the controller module CM#0 is specified as a transfer source and along which the controller module CM#0 is directly connected to a transfer destination and communication paths along which the controller module CM#0 is specified as a transfer source and along which the controller module CM#0 is connected to a transfer destination via a controller module 20, among the controller modules 20, that relays data, the data-flow-rate table 56 includes information indicating a transmission-channel abnormality flag and a data flow rate for each of the communication paths.

In the case of each of the communication paths along which the controller module CM#0 is specified as a transfer source and along which the controller module CM#0 is directly connected to a transfer destination, the controller module CM#0 is the controller module 20 that activates one of the DMAs 32 thereof. In the case of each of the communication paths along which the controller module CM#0 is specified as a transfer source and along which the controller module CM#0 is connected to a transfer destination via a controller module 20, among the controller modules 20, that relays data, the controller module 20 that relays data is the controller module 20 that activates one of the DMAs 32 thereof.

The communication paths along which the controller module CM#0 is the controller module 20 that activates one of the DMAs 32 thereof are the following three paths: a communication path from the controller module CM#0 to the controller module CM#1; a communication path from the controller module CM#0 to the controller module CM#2; and a communication path from the controller module CM#0 to the controller module CM#3. As transmission-channel abnormality flags for the communication paths along which the controller module CM#0 is the controller module 20 that activates one of the DMAs 32 thereof, the transmission-channel abnormality flags of the corresponding transmission channels D01, D02, and D03 that have been obtained from the performance information acquired from the performance-information storage buffer 37 are copied. Furthermore, as data flow rates for the communication paths along which the controller module CM#0 is the controller module 20 that activates one of the DMAs 32 thereof, the data flow rates of the corresponding transmission channels D01, D02, and D03 that have been obtained from the performance information acquired from the performance-information storage buffer 37 are copied. Accordingly, for example, in the case of the communication path along which the controller module 20 that activates one of the DMAs 32 thereof is the controller module CM#0 and along which the controller module 20 that is specified as a transfer destination is the controller module CM#1, the transmission-channel abnormality flag for the communication path is the same as the transmission-channel abnormality flag of the transmission channel D01, and a data flow rate F01 for the communication path is the same as a data flow rate DV01.

The communication paths along which the controller module CM#0 is not the controller module 20 that activates one of the DMAs 32 thereof are the following six paths: a communication path from the controller module CM#0 via the controller module CM#2 to the controller module CM#1; a communication path from the controller module CM#0 via the controller module CM#3 to the controller module CM#1; a communication path from the controller module CM#0 via the controller module CM#1 to the controller module CM#2; a communication path from the controller module CM#0 via the controller module CM#3 to the controller module CM#2; a communication path from the controller module CM#0 via the controller module CM#1 to the controller module CM#3; and a communication path from the controller module CM#0 via the controller module CM#2 to the controller module CM#3. A transmission-channel abnormality flag for each of the communication paths along which the controller module CM#0 is not the controller module 20 that activates one of the DMAs 32 thereof is the OR of the transmission-channel abnormality flags of corresponding two transmission channels obtained from the performance information acquired from the performance-information storage buffer 37. For example, in the case of the communication path from the controller module CM#0 via the controller module CM#2 to the controller module CM#1, the controller module CM#2 is the controller module 20 that activates one of the DMAs 32 thereof, and a transmission-channel abnormality flag for the communication path is the OR of the transmission-channel abnormality flag of the transmission channel D02 and the transmission-channel abnormality flag of the transmission channel D21. Furthermore, a data flow rate for each of the communication paths along which the controller module CM#0 is not the controller module 20 that activates one of the DMAs 32 thereof is the higher of two data flow rates of corresponding two transmission channels obtained from the performance information acquired from the performance-information storage buffer 37. For example, in the case of the communication path from the controller module CM#0 via the controller module CM#2 to the controller module CM#1, the controller module CM#2 is the controller module 20 that activates one of the DMAs 32 thereof, and a data flow rate F21 for the communication path is the higher of a data flow rate DV02 and a data flow rate DV21.

In this manner, each of the controller modules 20 may grasp, for each communication path, a highest data flow rate and whether or not abnormally occurs.

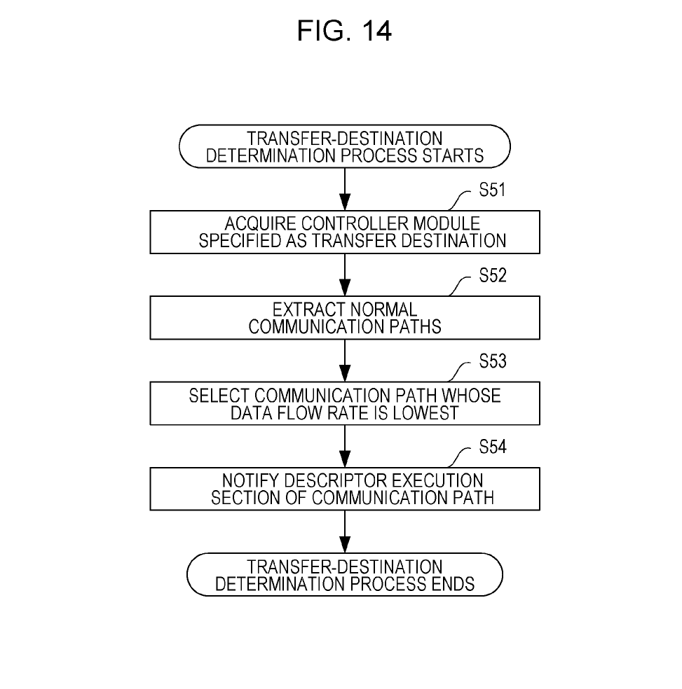

Next, a transfer-destination determination process will be described using FIG. 14. FIG. 14 is a flowchart of the transfer-destination determination process in the second embodiment.

The transfer-destination determination process is a process of determining, from the data-flow-rate table, a communication path along which data transfer is to be performed. The transfer-destination determination process is a process that is performed at a predetermined timing (for example, every one second) by the transfer-destination determination section 34.

[Operation S51] The transfer-destination determination section 34 acquires, from the descriptor execution section 33, a controller module 20, among the controller modules 20, that is specified as a transfer destination in the case of data transfer.

[Operation S52] The transfer-destination determination section 34 extracts, with reference to the transmission-channel abnormality flags included in the data-flow-rate table, normal communication paths (transmission channels) among the communication paths along which the determined controller module 20 is specified as a transfer destination.

[Operation S53] The transfer-destination determination section 34 extracts, with reference to the data flow rates included in the data-flow-rate table, among the extracted communication paths, a communication path (a transmission channel) whose data flow rate (the amount of transferred data) is the lowest.

[Operation S54] The transfer-destination determination section 34 notifies the descriptor execution section 33 of the communication path (transmission channel), and finishes the transfer-destination determination process.

In this manner, the transfer-destination determination section 34 may determine, at transfer-destination determination timing, a preferable communication path along which data is able to be transferred.

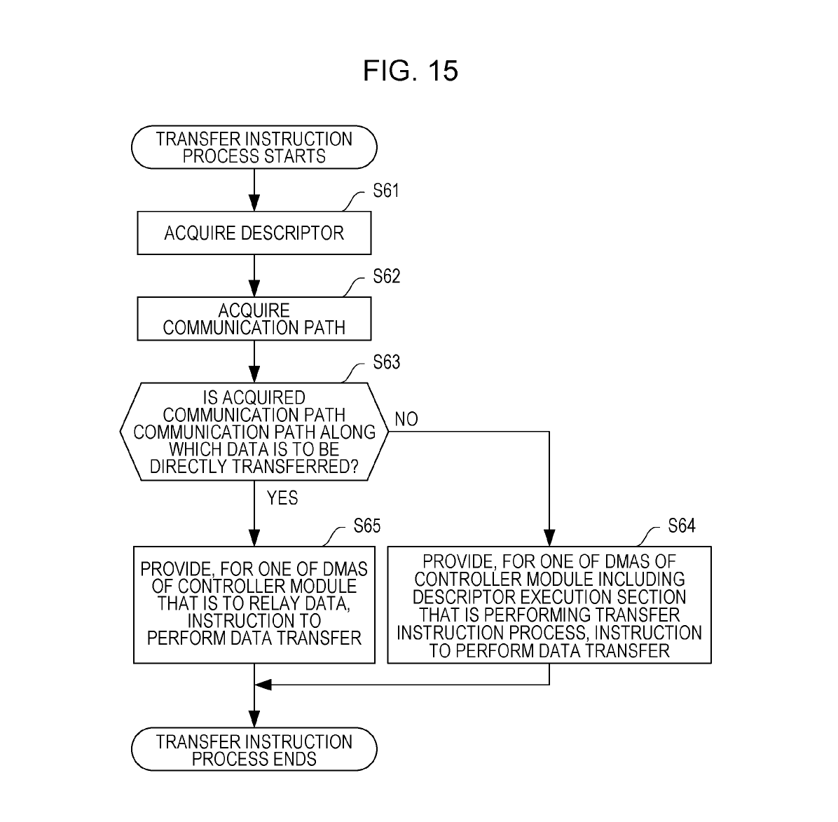

Next, a transfer instruction process will be described using FIG. 15. FIG. 15 is a flowchart of the transfer instruction process in the second embodiment.

The transfer instruction process is a process of providing, for a DMA that is to perform data transfer, an instruction to perform data transfer. The processor 22 that has set a descriptor provides, for the descriptor execution section 33, an instruction to start data transfer, and, consequently, the transfer instruction process is performed by the descriptor execution section 33.

[Operation S61] The descriptor execution section 33 acquires, from the cache memory 21, the descriptor that is specified by the processor 22.

[Operation S62] The descriptor execution section 33 acquires a communication path (transmission channel) from the transfer-destination determination section 34.

[Operation S63] The descriptor execution section 33 determines whether or not the communication path (transmission channel) is a communication path along which data is to be directly transferred from a transfer source to a transfer destination. When the communication path (transmission channel) is a communication path along which data is to be directly transferred from a transfer source to a transfer destination, the descriptor execution section 33 proceeds to operation S65. When the communication path (transmission channel) is not a communication path along which data is to be directly transferred from a transfer source to a transfer destination, that is, a communication path along which, among the controller modules 20, a controller module 20 is connected to a transfer destination via a controller module 20 that is to relay data, the descriptor execution section 33 proceeds to operation S64.

[Operation S64] The descriptor execution section 33 specifies the descriptor for one of the DMAs 32 of the controller module 20 that is to relay data, and provides, for the DMA 32, an instruction to perform data transfer. The descriptor execution section 33 finishes the transfer instruction process. The descriptor execution section 33 provides, for the DMA 32 of the controller module 20 that is to relay data, from the routing table 36, via the corresponding PCIe interface 39, an instruction to perform data transfer. The DMA 32 of the controller module 20 that is to relay data accepts, from the corresponding PCIe interface 39 of the controller module 20 that is to relay data, via the routing table 36 of the controller module 20 that is to relay data, the instruction to perform data transfer.

For example, when the transfer-destination determination section 34 of the controller module CM#0 determines that the acquired communication path is a communication path along which the controller module CM#1 is to relay data so that the data is transferred from the transmission channel D01 to the transmission channel D12, the descriptor execution section 33 issues a transfer instruction to one of the DMAs 32 of the controller module CM#1, from the routing table 36, via the PCIe interface PCIeINF#0. Furthermore, when the transfer-destination determination section 34 of the controller module CM#0 determines that the acquired communication path is a communication path along which the controller module CM#3 is to relay data so that the data is transferred from the transmission channel D03 to the transmission channel D32, the descriptor execution section 33 issues a transfer instruction to one of the DMAs 32 of the controller module CM#3, from the routing table 36, via the PCIe interface PCIeINF#2.

[Operation S65] The descriptor execution section 33 specifies the descriptor for one of the DMAs 32 of the controller module 20 including the descriptor execution section 33 which is performing this transfer instruction process, and provides, for the DMA 32, an instruction to perform data transfer. The descriptor execution section 33 finishes the transfer instruction process. The descriptor execution section 33 provides, for the DMA 32, an instruction to perform data transfer.

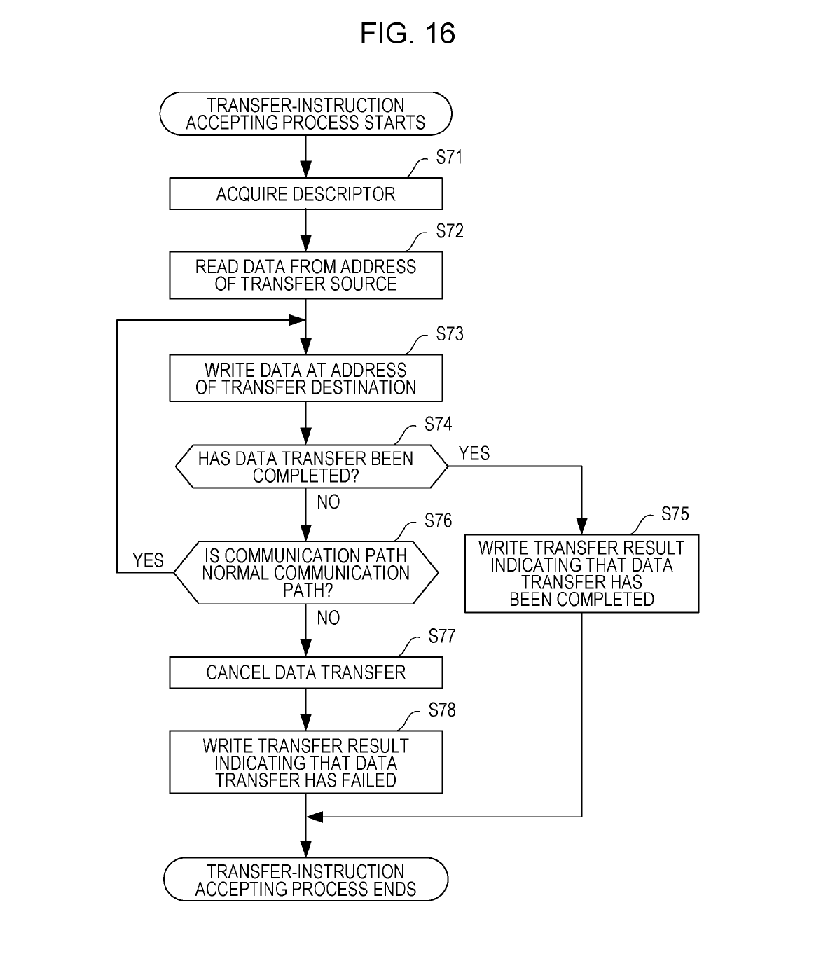

Next, a transfer-instruction accepting process will be described using FIG. 16. FIG. 16 is a flowchart of the transfer-instruction accepting process in the second embodiment.

The transfer-instruction accepting process is a process of performing data transfer, and is performed by a DMA 32, among the DMAs 32, that has accepted an instruction to perform data transfer. The transfer-instruction accepting process is performed by the DMA 32 that has accepted an instruction to perform data transfer from the descriptor execution section 33 of a controller module 20, among the controller modules 20, that is specified as a transfer source.

[Operation S71] The DMA 32 acquires a descriptor from the cache memory 21 of the controller module 20 that is specified as a transfer source. When the DMA 32 that has accepted an instruction to perform data transfer is not present in the controller module 20 that is specified as a transfer source, the DMA 32 acquires a descriptor via the corresponding PCIe interface 39 from the cache memory 21 of the controller module 20 that is specified as a transfer source.

[Operation S72] The DMA 32 reads data, the amount of data being specified, from the address of the data transfer source specified in the descriptor. When the DMA 32 that has accepted an instruction to perform data transfer is not present in the controller module 20 that is specified as a transfer source, the DMA 32 acquires data via the corresponding PCIe interface 39 from the cache memory 21 of the controller module 20 that is specified as a transfer source.

[Operation S73] The DMA 32 writes the read data at the address of the data transfer destination specified in the descriptor. When the DMA 32 that has accepted an instruction to perform data transfer is not present in the controller module 20 that is specified as a transfer source, the DMA 32 writes the data via the corresponding PCIe interface 39 into the cache memory 21 of a controller module 20, among the controller modules 20, that is specified as a transfer destination.

[Operation S74] The DMA 32 determines whether or not data transfer specified in the descriptor has been completed. When the data transfer has been completed, the DMA 32 proceeds to operation S75. When the data transfer has not been completed, the DMA 32 proceeds to operation S76.

[Operation S75] The DMA 32 writes a transfer result indicating that the data transfer has been completed at the address of the transfer-result notification destination specified in the descriptor, and finishes the transfer-instruction accepting process. When the DMA 32 that has accepted an instruction to perform data transfer is not present in the controller module 20 that is specified as a transfer source, the DMA 32 writes a transfer result via the corresponding PCIe interface 39 into the cache memory 21 of the controller module 20 that is specified as a transfer destination.

[Operation S76] The DMA 32 monitors the communication path (transmission channel) along which the data is being transferred, and determines whether or not the communication path is a normal communication path. When the communication path is a normal communication path, the DMA 32 proceeds to operation S73. When the communication path is not a normal communication path, the DMA 32 proceeds to operation S77.

The communication path along which the data is being transferred may be monitored by referring to the transmission-channel abnormality flags included in the performance information stored in the performance-information storage buffer 37. Alternatively, the communication path along which the data is being transferred may be monitored by monitoring the states of the PCIe interfaces 39 that are present along the communication path.

Regarding monitoring of a communication path, in the case where data is directly transferred from the controller module CM#0 that is specified as a transfer source to the controller module CM#2 that is specified as a transfer destination, one of the DMAs 32 of the controller module CM#0 that is specified as a transfer source monitors the transmission channel D02. Furthermore, regarding monitoring of a communication path, in the case where data is transferred from the controller module CM#0 that is specified as a transfer source to the controller module CM#2 that is specified as a transfer destination via the controller module CM#1 that relays data, one of the DMAs 32 of the controller module CM#1 that relays data monitors the transmission channels D01 and D12.

[Operation S77] The DMA 32 cancels the data transfer.

[Operation S78] The DMA 32 writes a transfer result indicating that the data transfer has failed at the address of the transfer-result notification destination specified in the descriptor, and finishes the transfer-instruction accepting process. When the DMA 32 that has accepted an instruction to perform data transfer is not present in the controller module 20 that is specified as a transfer source, the DMA 32 writes a transfer result via the corresponding PCIe interface 39 into the cache memory 21 of the controller module 20 that is specified as a transfer destination.

In this manner, the storage apparatus 10 may have redundancy of data transfer paths without using switches. Thus, severe damage to the redundancy configuration and marked reduction in the data transfer capability due to malfunctioning of switches do not occur. For example, in the case where switches are provided, the range of transmission channels with which data is not able to be transferred due to malfunctioning of the switches increases. However, in the case where the controller modules 20 are connected to each other in a mesh topology, the range of transmission channels with which data is not able to be transferred due to malfunctioning of the switches is limited to a portion having a malfunction.

Furthermore, in the storage apparatus 10, in the case where data is directly transferred between controller modules 20 among the controller modules 20, a controller module 20 that is specified as a transfer source may check a communication state. In the case where data is transferred via a controller module 20, among the controller modules 20, that relays the data, in the storage apparatus 10, one of the DMAs 32 of the controller module 20 that relays the data may check a state of communication between a controller module 20 that is specified as a transfer source and the controller module 20 that relays the data and a state of communication between the controller module 20 that relays the data and a controller module 20 that is specified as a transfer destination. Accordingly, in the storage apparatus 10, data transfer may be easily guaranteed.

Moreover, in the storage apparatus 10, according to the descriptor, the address of a transfer-result notification destination is an address located in the cache memory 21 of the controller module 20 that is specified as a transfer source. Thus, the processor 22 of the controller module 20 that is specified as a transfer source may easily grasp a transfer result.

Additionally, in the storage apparatus 10, the controller modules 20 are connected to each other in a mesh topology. Thus, the amounts of data to be transferred along the individual communication paths may be distributed. The amount of data to be transferred along one communication path may be reduced. In the storage apparatus 10, the cost of communication may be reduced by reducing the amount of data to be transferred.

Therefore, the storage apparatus 10 may guarantee, without any heavy load, data transfer in module-to-module communication using the redundancy of data transfer paths.

A method and system are described herein to control data transfer including establishing communication channels between a plurality of controller modules in a mesh topology, where the controller modules connect with a respective storage device. The method includes selecting one of a direct path and an indirect path for transferring data between a source and a destination among the plurality of controller modules, based on a communication state monitored between the source and the destination.

Note that the above-described processing functions may be realized by a computer. In this case, code is provided, in which the details of the processes of the functions that the storage apparatus 1 or the storage apparatus 10 (the controller module 20) may have are described. The code is executed by a computer, whereby the processing functions are realized on the computer. The code in which the details of the processes are described may be recorded on a computer-readable recording medium. Examples of the computer-readable recording medium include a magnetic storage device, an optical disk, a magneto-optical recording medium, and a semiconductor memory. Examples of the magnetic storage device include an HDD, a flexible disk (FD), and a magnetic tape. Examples of the optical disk include a digital versatile disk (DVD), a DVD-RAM, and a compact disc read-only memory/rewritable (CD-ROM/RW). Examples of the magneto-optical recording medium include a magneto-optical disk (MO).

In order to distribute the code, for example, a portable recording medium, such as a DVD or a CD-ROM, on which the code is recorded is sold. Alternatively, the code may be stored in a storage device of a server computer, and the code may be transferred from the server computer to another computer.

The computer that executes the code stores, for example, in a storage device of the computer, the code recorded on the portable recording medium or the code that has been transferred from the server computer. Then, the computer reads the code from the storage device thereof, and performs a process in accordance with the code. Note that the computer may directly read the code from the portable recording medium, and may perform a process in accordance with the code. Alternatively, every time when code is transferred from a server computer that is connected to the computer via a network, the computer may perform a process in accordance with the received code.

At least some of the above-described processing functions may be realized by an electronic circuit such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention the scope of which is defined in the claims and their equivalents.

What is claimed is:

1. A storage apparatus, comprising:
first, second, and third controller modules configured to have a cache memory and to control a storage device, respectively; and
communication channels that connect the first, second, and third controller modules in a mesh topology, and
wherein the first controller module provides an instruction, for the third controller module, to perform data transfer specifying the first controller module as a transfer source and the second controller module as a transfer destination, the third controller module being directly connected with each of the first and second controller modules using a corresponding one of the communication channels, and
the third controller module performs data transfer from the cache memory of the first controller module to the cache memory of the second controller module in accordance with the instruction.

2. The storage apparatus according to claim 1, comprising:
a transferer provided to the third controller module to monitor a communication state of, among the communication channels, a communication channel that connects the first controller module and the third controller module and a communication state of a communication channel that connects the third controller module and the second controller module, and perform the data transfer based on a result of monitoring of the communication states.

3. The storage apparatus according to claim 2, comprising:
an instructor provided to the first controller module, where the instructor stores transfer control information in the cache memory of the first controller module, and the transferer acquires the transfer control information and performs the data transfer.

4. The storage apparatus according to claim 3, wherein the transferer stores a result of the data transfer at an address specified in the transfer control information.

5. The storage apparatus according to claim 4, wherein the address at which the result of the data transfer is stored is an address located in the cache memory of the first controller module.

6. The storage apparatus according to claim 1,
wherein each of the first, second, and third controller modules includes:
a monitor configured to monitor a communication state of each of the communication channels in such a manner as to monitor a communication interface for each of the communication channels, and
a storage configured to store the communication state of each of the communication channels, and
wherein the instructor determines, based on the communication state of each of the communication channels stored in a storage of the first controller module, an instruction that is to be provided for the third controller module.

7. The storage apparatus according to claim 1, wherein the transferer performs data transfer using direct memory access.

8. A module-to-module data transfer method for a storage apparatus, the method comprising:
establishing communication channels between first, second, and third controller modules of the storage apparatus, each of the first, second, and third controller modules being configured to have a cache memory and to control a storage device, and the communication channels connecting the first, second, and third controller modules in a mesh topology;
providing an instruction, using the first controller module, for the third controller module to perform data transfer in which the first controller module is specified as a transfer source and the second controller module is specified as a transfer destination, the third controller module being directly connected with each of the first and second controller modules using a corresponding one of the communication channels; and
performing, using the third controller module, data transfer from the cache memory of the first controller module to the cache memory of the second controller module in accordance with the instruction.

9. The module-to-module data transfer method according to claim 8, comprising:
monitoring a data flow rate of a transmission channel between the first controller module and the third controller module and a data flow rate of a transmission channel between the third controller module and the second controller module.

10. The module-to-module data transfer method according to claim 9, comprising:
controlling the data transfer by switching a transfer direction to a transmission channel directly connecting the first controller module with the second controller module based on a result of the monitoring.

11. A data transfer method, comprising:
establishing communication channels between a plurality of controller modules in a mesh topology, the controller modules being connected with a respective storage device; and
selecting one of a direct path and an indirect path for transferring data between a source and a destination among the plurality of controller modules, based on a communication state monitored between the source and the destination.
